(19) United States
(12) Patent Application Publication
(10) Pub. No.: US 2010/0046119 A1
(43) Pub. Date: Feb. 25, 2010

(54) HEAD SLIDER, MAGNETIC HEAD SLIDER AND MAGNETIC STORAGE DEVICE

(75) Inventors: Hikaru Watanabe, Kawasaki (JP); Akihide Jinzenji, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/476,300

(22) Filed: Jun. 2, 2009

(30) Foreign Application Priority Data
Aug. 21, 2008 (JP) 2008-212934

(51) Int. Cl. G11B 5/60

(52) U.S. Cl. 360/235.4; G9B/5.229

(57) ABSTRACT

A head slider includes a base surface extending in a first direction and a second direction orthogonal to the first direction, a pair of side pads that are spaced apart from each other in the second direction on the base surface and have air bearing faces of a predetermined height from the base surface, a pair of rib portions that extend from the side pads to an end of the base surface in the first direction and have faces of a height between the base surface and the air bearing faces, and a joint portion that connects opposing ends of the pair of rib portions in the first direction and has a face of a height between the base surface and the air bearing faces.

### CROSS-REFERENCE TO RELATED APPLICATION

This application is based upon and claims the benefit of priority of the prior Japanese Patent Application No. 2008-212934, filed on Aug. 21, 2008, the entire contents of which are incorporated herein by reference.

### FIELD

The present invention relates to a head slider, a magnetic head slider, and a magnetic storage device.

### BACKGROUND

Conventionally, a magnetic disk drive is equipped with a rotatable recording storage medium (magnetic disk) and a read/write element. The read/write element is held by a magnetic head slider supported by a head supporting mechanism, and the magnetic head slider may be placed in position over the magnetic disk.

The magnetic head slider has an air bearing face and flies over the magnetic disk with a given gap being kept therebetween due to kinetic pressure resulting from rotation of the magnetic disk. In the flying state, the magnetic head records information on the magnetic disk and reads information therefrom.

There is a magnetic disk having a load/unload mechanism (this may be called ramp mechanism), which causes the head slider to take shelter to a position isolated from the surface of the magnetic head to prevent the head slider from contacting the magnetic disk when the magnetic head is stationary. In the magnetic disk with the ramp mechanism, the head slider may contact the magnetic disk if a sufficient buoyant force is not secured at the time of loading the head slider over the magnetic disk from the shelter position. This contacting may damage the surface of the magnetic disk and may make it impossible to reproduce information recorded thereon in the worst case.

### SUMMARY

According to an aspect of the present invention, there is provided a head slider including: a base surface which exists in first and second directions; a pair of side pads that are spaced apart from each other in the second direction on the base surface and have air bearing faces of a predetermined height from the base surface; a pair of rib portions that extend from the side pads to an end of the base surface in the first direction and have faces of a height between the base surface and the air bearing faces; and a joint portion that connects opposing ends of the pair of rib portions in the first direction and has a face of a height between the base surface and the air bearing faces.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a perspective view of a hard disk drive in accordance with a first embodiment;

FIG. 2A is a perspective view of a head stack assembly illustrated in FIG. 1, and FIG. 2B is a cross-sectional view of the head stack assembly;

FIG. 3A is a perspective view of a magnetic head slider in accordance with the first embodiment, and FIG. 3B is a cross-sectional view of the magnetic head slider;

FIG. 4 is a graph describing changes of the flying height with respect to a disk warpage for a related art (FIG. 12A), a modification (FIG. 12B) of the related art and the first embodiment (FIG. 3A);

FIG. 5 is a graph describing load contact margins of the head sliders of the related art (FIG. 12A) and the first embodiment (FIG. 3A);

FIG. 6A illustrates flying performance of the first embodiment, and FIG. 6B illustrates flying performance of the related art;

FIG. 7 is a perspective view of a magnetic head slider in accordance with a second embodiment;

FIG. 8 illustrates a joint portion and a magnetic head holding portion illustrated in FIG. 7;

FIG. 9 is a perspective view of a magnetic head slider in accordance with a third embodiment;

FIG. 10 is a perspective view of a variation of the magnetic head slider illustrated in FIG. 9;

FIG. 11 is a perspective view of another variation of the magnetic head slider illustrated in FIG. 9; and

FIG. 12A is a perspective view of the related art, and FIG. 12B is a perspective view of a variation of the related art.

### DESCRIPTION OF EMBODIMENTS

First, art related to an aspect of the present invention will now be described.

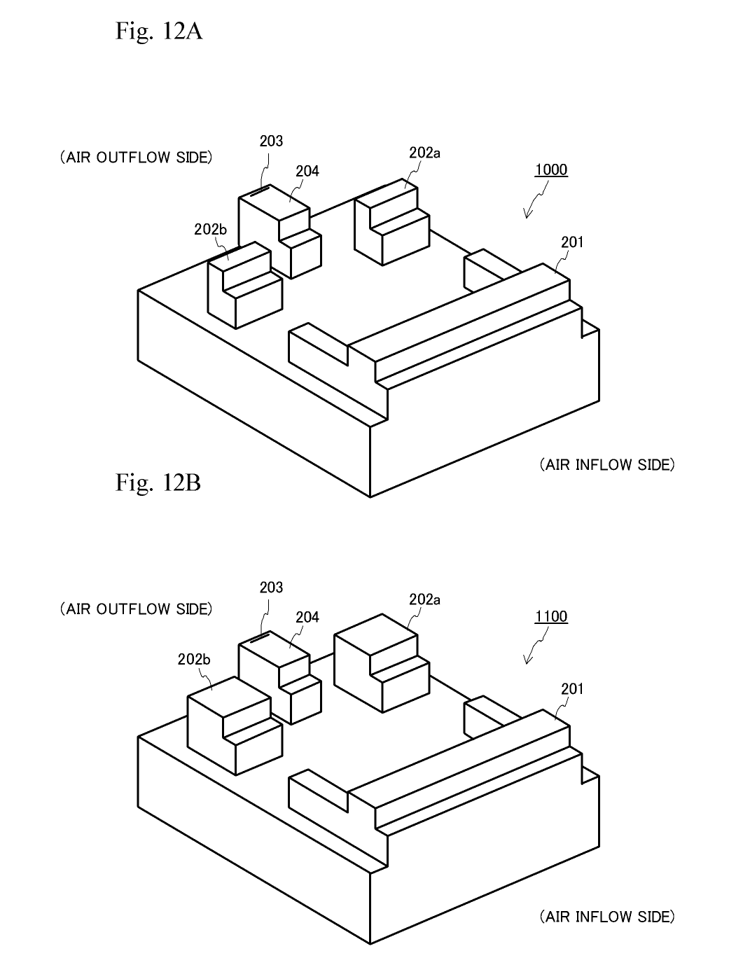

FIG. 12A is a perspective view of a related air bearing face (flying face) of a head slider 1000. As depicted, the head slider 1000 has a front rail 201, a pair of rear side rails 202a and 202b disposed on an air outflow side, and a rear center rail 204 that holds a magnetic head 203. The head slider 1000 may be modified, as illustrated in FIG. 12B, in which the uppermost surfaces (flying surfaces) of the side rails 202a and 202b located on the air outflow side are widened in order to secure a sufficient buoyant force at the time of loading the head slider. The wider uppermost surfaces of the side rails 202a and 202b increase the area in which the squeeze effect is available and thus increase the air resistance, so that the sufficient buoyant force can be secured at the time of loading.

However, the above modification has a disadvantage that an increased area that generates pressure in the read/write state (flying state) degrades the disk following performance and makes it difficult to realize the stable flying performance. Further, the recent trend narrows the gap between the head slider and the magnetic disk, and variations in flying due to disk warpage are not negligible.

There is a proposal directed to increasing the buoyant force at the time of loading, in which a surface having a height between the height of the uppermost surface and that of the lowermost surface is extended from pads at both ends of the slider flying face in the width direction (see U.S. Patent Application Publication No. 2007/0091506).

However, even the above proposal may not generate a sufficient buoyant force required at the time of loading.

According to an aspect of the present invention, there is provided a head slider capable of securing a sufficient buoyant force at the time of loading and realizing stable flying performance during read/write.

### First Embodiment

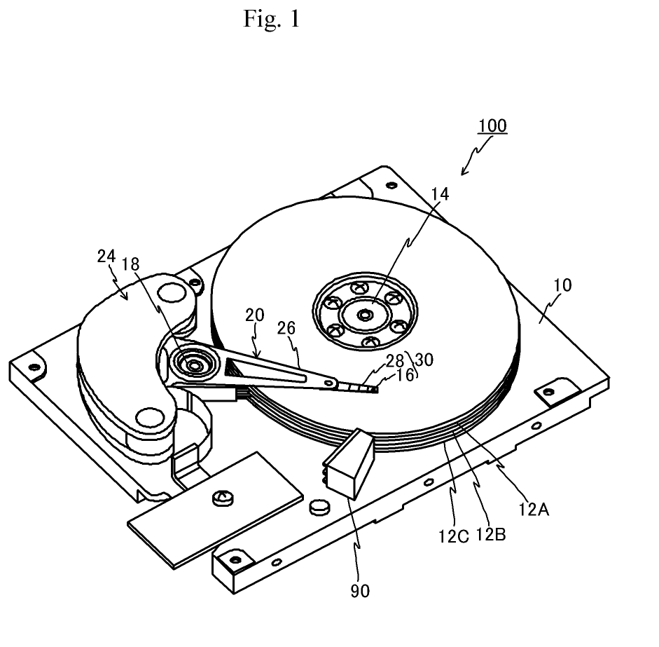

A description will now be given, with reference to FIGS. 1 through 6, of a first embodiment of the present invention.

FIG. 1 illustrates an internal structure of a hard disk drive (HDD) 100, which is an information storage device in accordance with the first embodiment. Referring to FIG. 1, the HDD 100 is composed of a base 10, three magnetic disks 12A, 12B and 12C supported by the base 10, a spindle motor 14, and a head stack assembly (HSA) 20. The base forms a box-like housing together with an upper lid (top cover) provided so as to cover the upper surface of the base 10. The top cover is not illustrated in FIG. 1 for the convenience' sake.

The front and back surfaces of each of the magnetic disks 12A through 12C include recording surfaces. The magnetic disks 12A through 12C are rotated about a rotary axis in one united body at a revolution as high as 4200 rpm to 15000 rpm.

The head stack assembly 20 is rotatably joined to a shaft 18, and is swung about the shaft 18 by a voice coil motor 24. The head stack assembly 20 has six head arms 26 and six head gimbal assemblies (HGA) 30 attached to ends of the six head arms 26.

The head arm 26 has a shape of an almost isosceles triangle viewed from the top (upper side), and may be formed by, for example, punching a stainless plate or extruding an aluminum material.

Each of the head gimbal assemblies 30 has an elastic suspension 28 and a magnetic head slider 16 attached to an end of the elastic suspension 28 having an opposite end attached to the shaft 18.

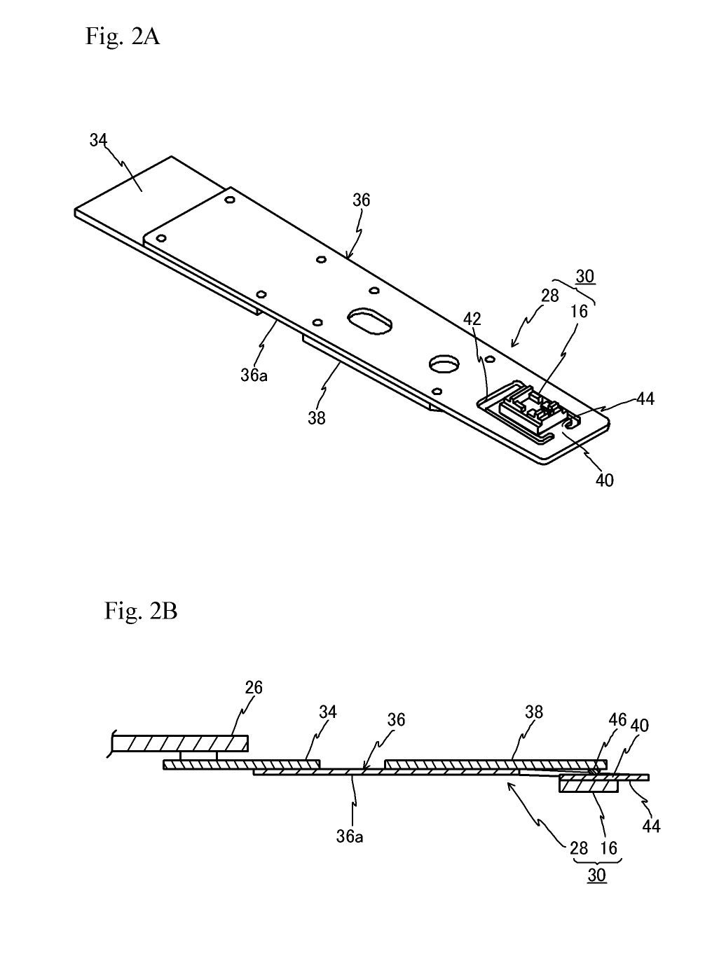

The detailed structure of the head gimbal assemblies 30 vertically stacked will now be described with reference to FIGS. 2A and 2B. FIG. 2A illustrates one of the six head gimbal assemblies 30 located at the top of the stack viewed from the side of the magnetic head slider 16 (back side), and FIG. 2B is a cross-sectional view of the top magnetic head gimbal assembly 30 shown in FIG. 2A.

As depicted in FIGS. 2A and 2B, the elastic suspension 28 of the head gimbal assembly 30 has a spacer 34, a load beam 36, and a reinforcing plate 38. The spacer 34 is fixed to an end of the head arm 26 opposite to another end attached to the shaft 18. An end of the load beam 36 is fixed to the spacer 34. The reinforcing plate 38 is fixed to the load beam 36.

The load beam 36 may be made of, for example, stainless steel, and has an approximately U-shaped slit 42 in the vicinity of an end opposite to the other end to which the spacer 34 is fixed. The slit 42 formed in the load beam 36 defines a gimbal 40 formed integrally with the load beam 36. A surface of a side of the gimbal 40 is a head slider holding surface 44 for holding the magnetic head slider 16. The head slider holding surface 44 is the upper surface of the gimbal 40 depicted in FIG. 2A, and is the lower surface thereof depicted in FIG. 2B. A portion of the load beam 36 interposed between a first portion to which the reinforcing plate 38 is fixed and a second portion to which the spacer 34 is fixed is an elastically deformable spring portion 36a.

The reinforcing plate 38 may be made of stainless steel. As illustrated in FIG. 2B, a pivot of a semi-spherical shape is provided to a portion of a surface (lower surface in FIG. 2B) of the reinforcing plate 38 that faces the gimbal 40. The pivot 46 is in contact with the gimbal 40 from the upper side. Thus, the gimbal 40 is deformable about the point of support in the vertical directions, pitch directions and roll directions. The magnetic head slider 1 is thus deformable to change the attitude in the same direction as the gimbal 40 is deformable.

Turning back to FIG. 1, a ramp mechanism (load/unload mechanism) 90 is provided above the movement locus of the end of the head stack assembly 20 at which the magnetic head slider 16 is provided. The ramp mechanism 90 holds the end of the head stack assembly 20 in a state in which the head stack assembly 20 is located in a stationary position.

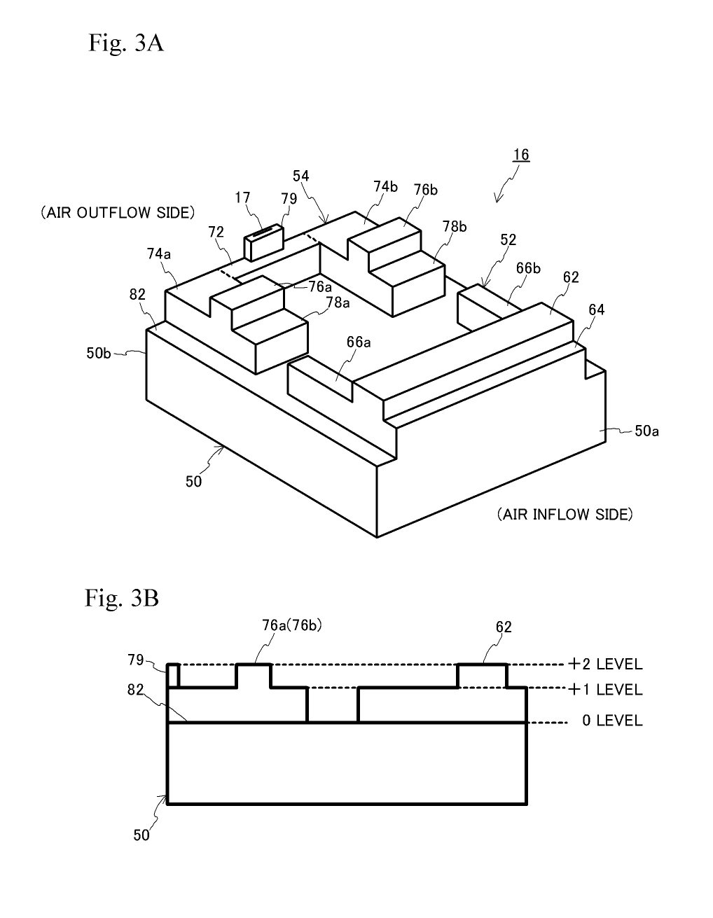

The structure of the magnetic head slider 16 will now be described with reference to FIGS. 3A through 6B.

FIG. 3A is a perspective view of the magnetic head slider 16 viewed from the side that faces the magnetic disk. Referring to FIG. 3A, the magnetic head slider 16 is composed of a head slider 50 and a read/write head element 17, which is a magnetic head provided on an air outflow end 50b of the head slider 50. The head slider 50 may be made of, for example, Al₂O₃ or TiC (AlTiC).

The read/write head element 17 is composed of a write element and a read element. The write element utilizes a magnetic field generated by, for example, a thin-film coil pattern to record data on the magnetic disk 12A. The read element is used to read data from the magnetic disk 12, and may be a giant magneto resistive (GMR) element utilizing a change of the resistance of a spin valve film or a tunnel junction magneto resistive (TMR) element utilizing a change of the resistance of a tunnel junction film. An alumina film, which may, for example, be tens of μm, is formed on the air outflow end 50b at which the read/write head element 17 is provided so as to cover the read/write head element 17.

As depicted in FIG. 3A, the upper surface of the head slider 50 that faces the magnetic disk) has a complicated shape having convexes and concaves. The upper surface of the head slider 50 has faces having different heights, as depicted in FIG. 3B, in which the uppermost face is labeled “+2 level”, and the lowermost face is labeled “0 (reference) level”, while an intermediate face is labeled “+1 level”. The 0-level face is a base surface 82 of the head slider 50. The distance between the +2-level height and the +1-level height may be 0.1 μm to 0.3 μm, and the distance between the +2-level height and the 0-level height may be 3 μm to 5 μm. It is to be noted that the figures may not be illustrated at the above-mentioned ratios correctly.

As illustrated in FIG. 3A, the head slider 50 has a front rail 52, and a rear rail 54. The front rail 52 is arranged on the side of the head slider 50 having the air inflow end 50a. The rear rail 54 is arranged on the opposite side of the head slider 50 having the air outflow end 50b. In other words, the rear rail 54 is closer to the air outflow end 50b than the front rail 52. The rails 52 and 54 may be defined by processing a rectangular block having a height equal to or greater than the +2 level by means of milling using the photolithographic technique with a photomask or photoresist. The rectangular block is finally shaped into the head slider 50. A protection film made of, for example, diamond-like carbon (DLC), is formed on the surfaces of the rails 52 and 54. In the head slider 50, a first axial direction is defined so as to connect the air inflow side and the air outflow side, and a second axial direction is defined so as to be orthogonal to the first axial direction.

The front rail 52 has an air bearing face 62 and step faces 64, 66a and 66b. The air bearing face 62 extends in the width direction of the head slider 50 and is located at the +2 level. The step faces 64, 66a and 66b are located at the +1 level. The step face 64 is a front step face located at the side of the air bearing face 62 at which the air inflow end 50a is provided. The step faces 66a and 66b are paired and are located at the side of the air bearing face 62 at which the air outflow end 50b is provided.

The rear rail 54 has air bearing faces 76a and 76b, step faces 78a and 78b, rib portions 74a and 74b, and a joint portion 72. The air bearing faces 76a and 76b are side pads located at the +2 level. The step faces 78a and 78b are provided at the sides of the air bearing faces 76a and 76b at which the air inflow end 50a is provided and are located at the +1 level. The rib portions 74a and 74b are provided at the other sides of the air bearing faces 76a and 76b at which the air outflow end 50b is provided and are located at the +1 level. The joint portion 72 joins the rib potions 74a and 74b and has an upper surface located at the +1 level. The rib portions 74a and 74b extend to the air outflow end 50b of the head slider 50, and the joint portion 72 joins the ends of the rib portions 74a and 74b on the air outflow end side. Thus, the head slider 50 has an appropriately C-shaped face that is defined by the rib portions 74a and 74b and the joint portion 72 and is located at the +1 level.

The head slider 50 has a magnetic head holding portion 79, which is located at the center of the joint portion 72 and holds the read/write head element 17.

In the magnetic head slider 16 thus structured, as compared to the related art illustrated in FIG. 12A, the face at the +1 level can be widened without widening the face at the +2 level including the air bearing faces 62, 76a and 76b.

The functions of the head slider 50 will now be described.

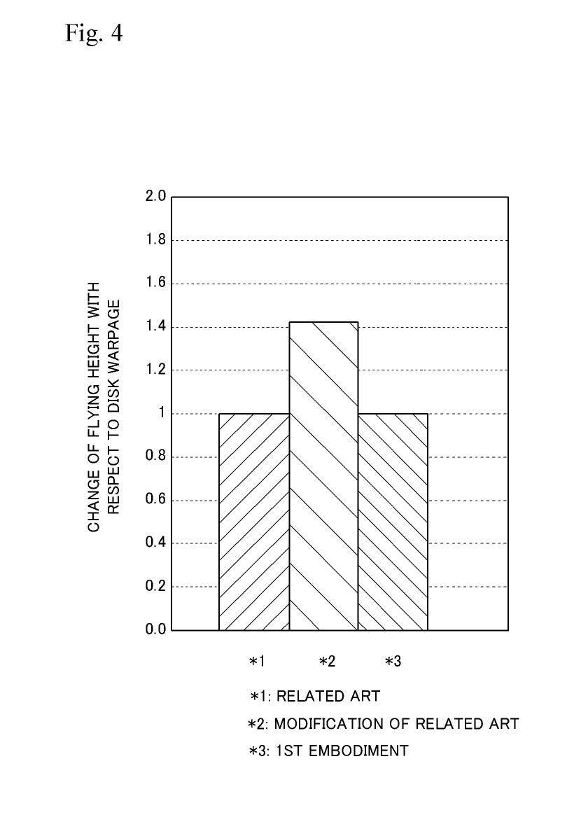

FIG. 4 is a graph describing changes of the flying height with respect to disk warpage for the related art (FIG. 12A), the modification (FIG. 12B) of the related art and the present embodiment (FIG. 3A). The disk following performance is better as the change of the flying height with respect to disk warpage is smaller.

As described in FIG. 4, the modification of the related art illustrated in FIG. 12B has the widened face at the +2 level, and the change of the flying height with respect to disk warpage is therefore 30 to 40% greater than that for the related art illustrated in FIG. 12A. In contrast, the present embodiment illustrated in FIG. 3A does not widen the face at the +2 level, and can achieve the change of the flying height that is almost the same as that for the related art. Even if a greater change of the flying height takes place, it will be an only 5% increase.

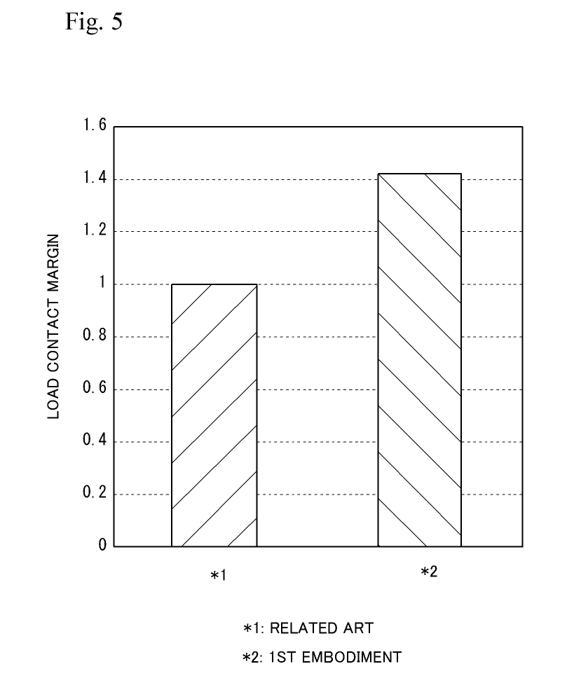

FIG. 5 is a graph describing load contact margins of the head sliders of the related art (FIG. 12A) and the present embodiment (FIG. 3A). The load contact margin defines the ranges of parameter conditions in which the magnetic head slider 16 is not brought into contact with the magnetic disk when several parameters involved in the flying attitude used in an analysis of the flying attitude of the magnetic head slider 16 at the time of loading are changed. Examples of the parameters are the inclination of the pitch static attitude (PSA) about the direction perpendicular to the drawing sheet of FIG. 2B, the inclination of the roll static attitude (RSA) about the horizontal direction of the drawing sheet of FIG. 2B, and the loading speed. The possibility that the magnetic head slider may contact the magnetic disk reduces as the load contact margin increases.

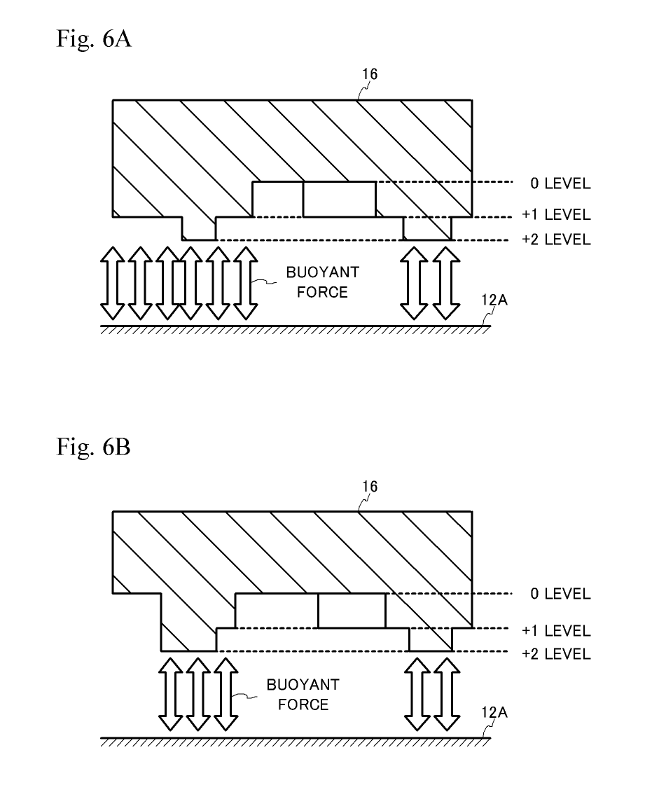

As illustrated in FIG. 5, the head slider 50 of the present embodiment has a smaller possibility that it may contact the magnetic disk than the head slider of the related art. The increased load contact margin provided by the present embodiment results from the widened faces at the +2 and +1 levels (particularly, the widened face at the +1 level), as compared to the related art. That is, the present embodiment is capable of securing the greater area (see FIG. 6A) that generates the squeeze effect at the time of loading than the area of the related art (see FIG. 6B). The greater area that generates the squeeze effect increases the air resistance, so that the increased buoyant force can be secured at the time of loading.

As described above, the present embodiment is capable of realizing the increased load contact margin (reduced possibility of contacting with the magnetic disk) as illustrated in FIG. 5, while the change of the flying height with respect to the disk warpage is maintained as illustrated in FIG. 4.

As described above, the first embodiment has the greater face at the +1 level because the pair of rib portions 74a and 74b located at the +1 level extend from the air bearing faces 76a and 76b to the end of the head slider 50 on the air outflow side and the opposing ends of the rib portions 74a and 74b on the air outflow side are joined by the joint portion 72 having the face at the +1 level. With this structure, it is possible to secure the greater buoyant force at the time of loading the magnetic head slider 16 over the magnetic disk than that available in the related art. It is thus possible to suppress the magnetic head slider 16 from contacting the magnetic disk and to reduce the possibility that the magnetic head slider 16 and the magnetic disk may be damaged. It is to be noted that the present embodiment does not increase the buoyant force by increasing the area at the +2 level. It is thus possible to restrain increase of pressure in the flying state and realize stable flying performance and to realize more reliable write and read with regard to the magnetic disk.

### Second Embodiment

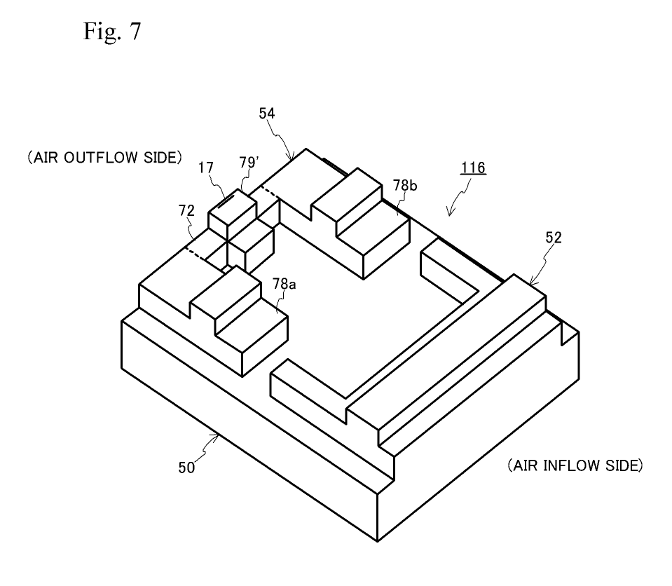

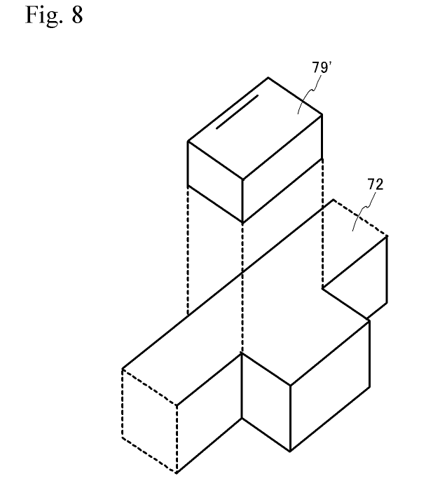

A description will now be given, with reference to FIGS. 7 and 8, of a second embodiment. A HDD of the second embodiment has a magnetic head slider different from that of the first embodiment. The other structures of the second embodiment are the same as those of the first embodiment, and a description thereof is omitted here.

As illustrated in FIG. 7, a magnetic head slider 116 of the second embodiment has a unique structure in which a magnetic head holding portion 79′ formed in a part of the joint portion 72 is greater than the magnetic head holding portion 79 of the magnetic head slider 16 of the first embodiment.

The arrangement of the joint portion 72 and the magnetic head holding portion 79′ may be considered as illustrated in FIG. 8, in which the joint portion 72 has an approximately T-shaped face at the +1 level, and the magnetic head holding portion 79′ having the face at the +2 level is placed on the joint portion 72 and is located at the center thereof. Of course, the actual magnetic head slider 116 does not have separate members because the concaves and convexes on the head slider can be defined by milling.

The second embodiment has the face at the +1 level as wide as the face at the +1 level in the first embodiment, and has advantages similar to those of the first embodiment.

### Third Embodiment

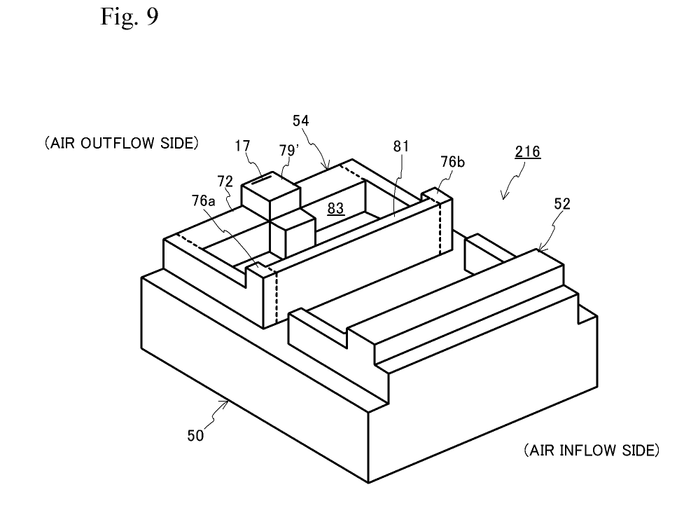

A third embodiment will now be described with reference to FIG. 9. A HDD of the third embodiment has a magnetic head slider different from those of the first and second embodiments. The other structures of the second embodiment are the same as those of the first embodiment, and a description thereof is omitted here.

As illustrated in FIG. 9, a magnetic head slider 216 of the third embodiment does not employ the step faces 78a and 78b employed in the magnetic head slider 116 (FIG. 7) of the second embodiment, and employs a joint portion 81, which is a pad joining portion that has a height of the +2 level and joins the air bearing faces (side pads) 76a and 76b.

The third embodiment has advantages similar to those of the second embodiment. The third embodiment has a space that is surrounded by walls and is located on the air outflow end side of the head slider 50. A negative pressure generated in the space 83 realizes stable flying performance in the read/write state.

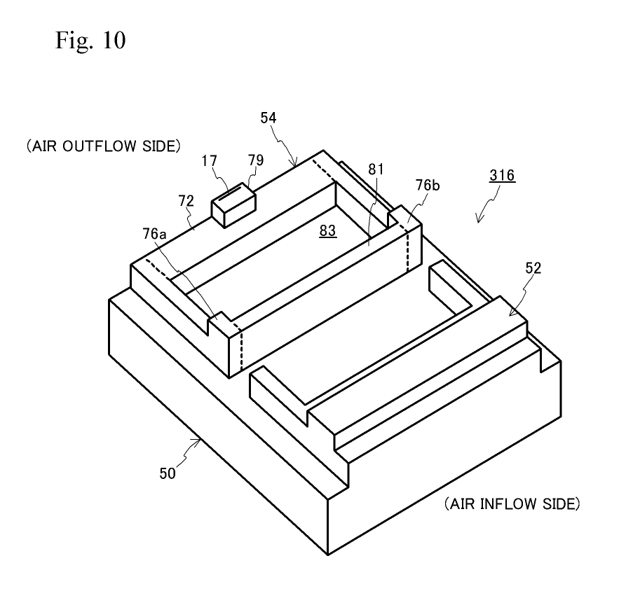

The third embodiment may be varied as illustrated in FIG. 10 so as to use the magnetic head holding portion 79 that is employed in the first embodiment and is smaller than the magnetic head holding portion 79′. This variation has advantages similar to those of the first embodiment and a further advantage that the stable flying performance can be realized in the read/write state due to the negative pressure generated in the space 83 surrounded by the walls.

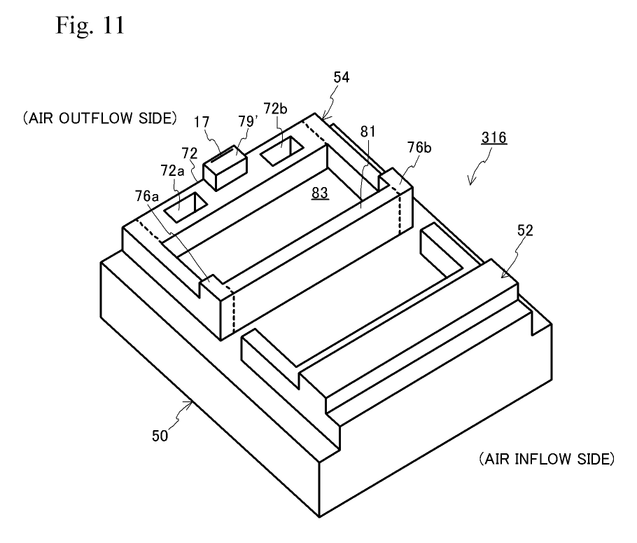

The structure illustrated in FIG. 10 may be varied as illustrated in FIG. 11, in which step portions 72a and 72b lower than the +1 level are formed in parts of the joint portion 72. The shape and arrangement of the step portions 72a and 72b are not limited to those illustrated in FIG. 11, and another shape and another arrangement may be employed. The step portions 72a and 72b may be higher than the +1 level. The step portions may be provided in the joint portion 72 of the magnetic head slider of the first or second embodiment.

In each of the first through third embodiments, the rib portions 74a and 74b and the joint portion 72 are all at the +1 level. However, the rib portions 74a and 74b and the joint portion 72 may have heights between the 0 level and the +2 level. For example, the heights of the rib portions and/or joint portion may increase or decrease gradually.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention.

What is claimed is:

1. A head slider comprising:
a base surface which exists in first and second directions;
a pair of side pads that are spaced apart from each other in the second direction on the base surface and have air bearing faces of a predetermined height from the base surface;
a pair of rib portions that extend from the side pads to an end of the base surface in the first direction and have faces of a height between the base surface and the air bearing faces; and
a joint portion that connects opposing ends of the pair of rib portions in the first direction and has a face of a height between the base surface and the air bearing faces.

2. The head slider according to claim 1, wherein the joint portion includes a face having a height equal to that of the air bearing faces.

3. The head slider according to claim 1, further comprising a pad joining portion that extends in the second direction to connect the pair of side pads and has a height equal to that of the air bearing portions.

4. The head slider according to claim 2, further comprising a pad joining portion that extends in the second direction to connect the pair of side pads and has a height equal to that of the air bearing portions.

5. A magnetic head slider comprising:
a head slider; and
a magnetic head
the head slider including:
a base surface extending in a first direction and a second direction orthogonal to the first direction;
a pair of side pads that are spaced apart from each other in the second direction on the base surface and have air bearing faces of a predetermined height from the base surface;
a pair of rib portions that extend from the side pads to an end of the base surface in the first direction and have faces of a height between the base surface and the air bearing faces; and
a joint portion that connects opposing ends of the pair of rib portions in the first direction and has a face of a height between the base surface and the air bearing faces,
the magnetic head being attached to the joint portion.

6. A magnetic storage device comprising:
a magnetic storage medium;
a head slider that flies over the magnetic storage medium in read/write; and
a magnetic head,
the head slider including:
a base surface extending in a first direction and a second direction orthogonal to the first direction;
a pair of side pads that are spaced apart from each other in the second direction on the base surface and have air bearing faces of a predetermined height from the base surface;
a pair of rib portions that extend from the side pads to an end of the base surface in the first direction and have faces of a height between the base surface and the air bearing faces; and
a joint portion that connects opposing ends of the pair of rib portions in the first direction and has a face of a height between the base surface and the air bearing faces,
the magnetic head being attached to the joint portion.
